(19) United States
(12) Patent Application Publication
(10) Pub. No.: US 2014/0265844 A1
(43) Pub. Date: Sep. 18, 2014

(54) Ripple Reducing LED Driver

(71) Applicants: Laurence P. Sadwick, Salt Lake City, UT (US); William B. Sackett, Salt Lake City, UT (US)

(72) Inventors: Laurence P. Sadwick, Salt Lake City, UT (US); William B. Sackett, Salt Lake City, UT (US)

(21) Appl. No.: 14/218,822

(22) Filed: Mar. 18, 2014

Related U.S. Application Data
(60) Provisional application No. 61/786,415, filed on Mar. 15, 2013.

(51) Int. Cl. H05B 33/08

(52) U.S. Cl. CPC H05B 33/0815
USPC 315/85

(57) ABSTRACT

An LED driver with current limiter and output ripple reduction.

### BACKGROUND

Electricity is generated and distributed in alternating current (AC) form, wherein the voltage varies sinusoidally between a positive and a negative value. However, many electrical devices require a direct current (DC) supply of electricity having a constant voltage level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation. Electrical current flows through an individual LED easily in only one direction, and if a negative voltage which exceeds the reverse breakdown voltage of the LED is applied, the LED can be damaged or destroyed. Furthermore, the standard, nominal residential voltage level is typically something like 120 VAC or 240 VAC for many parts of the world, both of which are often higher than may be desired for a high efficiency LED or OLED light. Some conversion of the available power may therefore be necessary or highly desired with loads such as an LED or OLED light.

Drivers or power supplies for loads such as an LED or an OLED or arrays of either or both may be configured to provide a desired load current based on the expected line voltage. However, for example, in input overvoltage conditions, the load condition may rise unacceptably and damage the load.

### SUMMARY

A ripple reducing LED driver is disclosed that reduces current ripple to a load during, for example, AC input non-dimming or dimming conditions. A detector in the current limiting LED driver detects conditions and limits the load current while actively reducing the output ripple. For example, in some embodiments of the current limiting and ripple reducing LED driver, a detection, feedback and control circuit controls a variable pulse generator that drives a main input power switch to adjust the load current. The pulse width of the variable pulse generator is set to a constant value during normal operation to provide the desired load current based on input voltage conditions. For example, the variable pulse generator may include a DC voltage to pulse width converter, with a current source and resistor combination providing the DC reference voltage to set the pulse width. During various input conditions including dimming with a Triac, Triac-based or other forward or reverse phase angle/phase cut dimmers, the detector, feedback and control signals change, as an example, the reference voltage that controls the current, reducing the DC reference voltage and causing the pulse width from the variable pulse generator to be reduced, limiting load current while also reducing the output ripple current. The present invention is not limited to the example above and applies and can be applied to both isolated and non-isolated power supplies and drivers in general including LED power supplies and drivers. Although current limiting and ripple reduction example embodiments are presented here, the present invention can also be used for voltage and or power limiting. The embodiments shown and discussed are intended to be examples of the present invention and in no way or form should these examples be viewed as being limiting of and for the present invention.

This summary provides only a general outline of some particular embodiments. Many other objects, features, advantages and other embodiments will become more fully apparent from the following detailed description.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a block diagram of an LED driver with a current limiter and ripple reduction for a non-isolated driver in accordance with some embodiments of the invention;

FIG. 2 depicts a block diagram of an LED driver with a current limiter and ripple reduction for an isolated driver in accordance with some embodiments of the invention;

FIG. 3 depicts a block diagram of an LED driver with a current limiter and ripple reduction for an isolated driver where the detection signal(s) can be on the secondary side in accordance with some embodiments of the invention;

FIG. 4 depicts a schematic of an example LED driver with a current limiter and a ripple reduction in accordance with some embodiments of the invention.

### DESCRIPTION

A current limiting and output ripple reduction LED driver, which can also be used for applications and purposes and power supplies and drivers other than LED drivers, is disclosed that, for example, limits and reduces ripple current to a load during both input non-dimming and dimming conditions. An overvoltage detector in the current limiting LED driver detects input overvoltage conditions and limits the load current. For example, in some embodiments of the current limiting LED driver, a variable pulse generator controls a main input power switch to adjust the load current. The pulse width of the variable pulse generator is set to a constant value during normal operation to provide the desired load current based on expected input voltage conditions. For example but in no way intended to be limiting, the variable pulse generator may include a DC voltage to pulse width converter, with a current source and resistor combination providing the DC reference voltage to set the pulse width. During input overvoltage conditions, the overvoltage detector changes the resistance connected to the current source, reducing the DC reference voltage and causing the pulse width from the variable pulse generator to be reduced, limiting load current. The present invention also provides high power factor.

Examples of LED drivers that may incorporate a current limiter and ripple reducer disclosed herein include those in U.S. patent application Ser. No. 13/404,514, filed Feb. 24, 2012 for a “Dimmable Power Supply”, in U.S. patent application Ser. No. 12/776,409, filed May 9, 2010 for a “LED Lamp with Remote Control”, in U.S. patent application Ser. No. 13/674,072 filed Nov. 11, 2012 for a “Dimmable LED Driver with Multiple Power Sources”, and in U.S. patent application Ser. No. 13/299,912 filed Nov. 18, 2011 for a “Dimmable Timer-Based LED Power Supply” which are all incorporated herein by reference for all purposes. Such a driver provides power for lights such as LEDs of any type and other loads.

Turning to FIG. 1, a block diagram of an LED driver is depicted as an example application of a current limiter and ripple reducer in accordance with some embodiments of the invention. A source 100 of AC input power typically at 50 or 60 Hz is either directly supplied to the input of an EMI and AC to DC rectification stage 102 or the AC input is applied to a Triac, Triac-based, other forward or reverse dimmer, etc. for which the output of such a dimmer is applied to the input of an EMI and AC to DC rectification stage 102 of the present invention. A variable pulse generator 104 drives a non-isolated stage 106 which could be of any type including but not limited to buck, boost-buck, buck-boost, boost, cuk, SEPIC, etc. which directly drives a switch that ultimately controls, via the dimming and Ripple Detect/Control stage 108, current through an output stage and load 110, drawing power for example from an AC input 100 through a rectifier 102 as mentioned above, or in other embodiments from a DC source. The dimming information may be detected from the rectified AC to DC voltage appearing at the output of the EMI filter and AC to DC Rectification Stage 102. The variable pulse generator 104 provides a series of control pulses to a switch, based on feedback and information from the Dimming and Ripple Detect/Control stage 108 setting the current through the load 110 to a desired level based on the input voltage from AC input 100 or dimmer (or from any other voltage input). In some embodiments, the variable pulse generator 104 produces pulses at a much higher frequency than that at the AC input 100.

A pulse width controller sets the pulse width frequency from the variable pulse generator 104. The use of one or more tagalong inductors including to provide bias, power, efficiency boost, information, including dimming, current, etc. may be included in various embodiments of the present invention. An overvoltage detector (not shown in the figures) and current limiter/ripple reduction/dimming control overrides the pulse width controller or otherwise acts to reduce the pulse width or turn off the pulses from the variable pulse generator 104 based on the input conditions and the maximum allowable/set current including if a parameter(s) exceeds that expected or reaches a level that would damage the load 110 or other components. The block diagram depicted in FIG. 1 is intended to provide an example of the present invention and is in no way intended to be limiting in any way or form for the present invention.

Turning to FIG. 2, another block diagram of an LED driver is depicted as an example application of a current limiter and ripple reducer in accordance with some embodiments of the invention. A source 100 of AC input power typically at 50 or 60 Hz is either directly supplied to the input of an EMI filter and AC to DC rectification stage 102 or the AC input 100 is applied to a Triac, Triac-based, other forward or reverse dimmer, etc. for which the output of such a dimmer is applied to the input of an EMI filter and AC to DC rectification stage 102 of the present invention. A variable pulse generator 104 drives an isolated stage 112 which could be of any type including but not limited to fly-back, one, two, and higher stage, forward converters, SEPIC, etc. which drives a switch that ultimately controls, via the dimming and Ripple Detect/Control stage 108, current through an output stage and load 110, drawing power for example from an AC input 100 through a rectifier 102 as mentioned above, or in other embodiments from a DC source. The dimming information may be detected from the rectified AC to DC voltage appearing at the output of the EMI filter and AC to DC Rectification Stage 102. The variable pulse generator 104 provides a series of control pulses to a switch, based on feedback and information from the Dimming and Ripple Detect/Control stage 108 setting the current through the load 110 to a desired level based on the input voltage from AC input 100 or dimmer (or from any other voltage input). In other embodiments, a non-isolated driver or power supply, including but not limited to buck, boost, buck-boost, boost-buck, etc. may be used for in the present invention. The use of one or more additional and/or bias/detection windings including to provide bias, power, efficiency boost, information, including dimming, current, etc. may be included in various embodiments of the present invention. In most embodiments, the variable pulse generator 104 produces pulses at a much higher frequency than that at the AC input 100.

A pulse width controller sets the pulse width frequency from the variable pulse generator 104. An overvoltage detector (not shown in the figures) and current limiter/ripple reduction/dimming control overrides the pulse width controller 104 or otherwise acts to reduce the pulse width or turn off the pulses from the variable pulse generator 104 based on the input conditions and the maximum allowable/set current including if a parameter(s) exceeds that expected or reaches a level that would damage the load or other components. The block diagram depicted in FIG. 2 is intended to provide an example of the present invention and is in no way intended to be limiting in any way or form for the present invention.

Turning to FIG. 3, another block diagram of an LED driver is depicted as an example application of a current limiter and ripple reducer in accordance with some embodiments of the invention. A source 100 of AC input power typically at 50 or 60 Hz is either directly supplied to the input of an EMI and AC to DC rectification stage 102 or the AC input 100 is applied to a Triac, Triac-based, other forward or reverse dimmer, etc. for which the output of such a dimmer is applied to the input of an EMI and AC to DC rectification stage 102 of the present invention. A variable pulse generator 104 drives an isolated stage 112 which could be of any type including but not limited to fly-back, one, two, and higher stage, forward converters, SEPIC, etc. which drives a switch that ultimately controls, via the dimming and Ripple Detect/Control stage 108, current through an output stage and load 110, drawing power for example from an AC input 100 through a rectifier 102 as mentioned above, or in other embodiments from a DC source. The dimming information may be detected from a winding including, but not limited to, the secondary winding from one (or more) of the isolation transformer or flyback transformer(s). The variable pulse generator 104 provides a series of control pulses to a switch, based on feedback and information from the Dimming and Ripple Detect/Control stage 108 setting the current through the load 110 to a desired level based on the input voltage from AC input 100 or dimmer (or from any other voltage input). In other embodiments, a non-isolated driver or power supply, including but not limited to buck, boost, buck-boost, boost-buck, etc. may be used for in the present invention. The use of one or more additional and/or bias/detection windings including to provide bias, power, efficiency boost, information, including dimming, current, etc. may be included in various embodiments of the present invention. In most embodiments, the variable pulse generator 104 produces pulses at a much higher frequency than that at the AC input 100.

A pulse width controller sets the pulse width frequency from the variable pulse generator 104. An overvoltage detector (not shown in the figures) and current limiter/ripple reduction/dimming control overrides the pulse width controller or otherwise acts to reduce the pulse width or turn off the pulses from the variable pulse generator 104 based on the input conditions and the maximum allowable/set current including if a parameter(s) exceeds that expected or reaches a level that would damage the load or other components. The block diagram depicted in FIG. 3 is intended to provide an example of the present invention and is in no way intended to be limiting in any way or form for the present invention.

Turning to FIG. 4, an example schematic diagram of a LED driver is depicted as an example application of a current limiter in accordance with some embodiments of the invention. An example buck version of the present invention is depicted in FIG. 4. For clarity, some elements of a typical driver including an EMI filter, power sources, overvoltage protection, etc. are not shown in FIG. 4. A switch 212 which is driven by the controller shown in FIG. 4 sets the current to and through the output stage and load 150, drawing power, for example, from an AC input 120 which could include a dimmer such as a Triac, Triac-based, or other forward or reverse dimmers, through a rectifier 124, or in other embodiments from a DC source. A variable pulse generator 216 provides a series of pulses to the switch 212, setting the current through the load 150 to a desired level based on the expected input voltage from AC input 120 (or from any other voltage input). In some embodiments, the variable pulse generator 216 produces pulses at a much higher frequency than that at the AC input 120.

A pulse width controller 218 sets the pulse width frequency from the variable pulse generator 216. A detector and current limiter adapts and modifies the pulse width controller 218 or otherwise acts to change the pulse width or turn off the pulses from the variable pulse generator 216 if the output current or drain voltage of transistor 156 exceeds that expected or reaches a level that would damage the load or other components. The present invention works with/for discontinuous conduction mode (DCM), continuous conduction mode (CCM), critical conduction mode (CRM), resonant conduction mode, synchronous rectification, etc.

A dimmable constant current is supplied to the load 150, regulated by a switch such as a transistor 156 and set by feedback to the controller which controls the variable pulse generator 216 that feeds and drives switch 212, again, under the control of a the signal to the variable pulse generator 216. The transistor 212 (and other transistors 142, 156) may be any suitable type of transistor or other device, such as a MOSFET or bipolar transistor or field effect transistor of any type and material including but not limited to metal oxide semiconductor FET (MOSFET), junction FET (JFET), bipolar junction transistor (BJT), heterojunction bipolar transistor (HBT), insulated gate bipolar transistor (IGBT), etc., and can be made of any suitable material including but not limited to silicon, gallium arsenide, gallium nitride, silicon carbide, etc. which has a suitably high voltage rating. An AC input, which could be the AC lines 120 or a dimmer connected to the AC is rectified in a rectifier 124 such as a diode bridge and may be conditioned using a capacitor which may or may not be part of an electromagnetic interference (EMI) filter (not shown) which may be connected to the AC input and/or on the DC side of the bridge to reduce interference, and a fuse 122 or similar device or devices may be used to protect the driver and wiring from excessive current due to short circuits or other fault conditions.

The variable pulse generator 216 generates pulses that turn the transistor 212 on and off, with the on-time of the pulses or pulse width controlled by the design and implementation of the driver.

The bias supply including one generated by a tagalong inductor may be used to power internal components as well, such as the variable pulse generator 216 and controller and an detector(s)/current limiter(s). The bias supply may be set at any suitable voltage level and may be generated by any suitable device or circuit.

An inductor 130 and the load 150 are connected with the switch 212, and a diode 126 is connected to the inductor 130 and the load 150. When the transistor 212 is turned on or closed, current flows from the rectified DC from the bridge 124 through the load and energy is stored in the inductor 130. When the transistor 212 is turned off, energy stored in the inductor 130 is released through the load with the diode 126 forming a return path for the current through the load 150 and inductor 130. The inductor 130, load 150 and diode 126 thus form a load loop in which current continues to flow briefly when the transistor 212 is off. In some embodiments, the load loop is placed above the switch 212; in other embodiments, the load loop is placed below the switch 212. Other optional components such as capacitors, inductors, resistors and switches, etc. may be included in the driver for various purposes.

A voltage divider (not shown) may be included that sets the pulse width from the variable pulse generator 216 as needed to produce the desired load current when the DC input is at the expected normal voltage level. When the voltage at the DC input rises, for example during transients, if connected to an incorrect AC input, or due to any other overvoltage conditions, etc., the voltage at, for example, the bias supply (not shown) will rise, causing the overvoltage detector/current limiter to lower the voltage at a control node to reduce the pulse width from the variable pulse generator 216.

In FIG. 4, inductor 130 and diode 126 form a buck stage which supplies power to the load 150 and to any optional or needed capacitors represented by 132. Resistors 134 and 140, transistor 142, diode 136 and optional capacitor 144 provide a regulated voltage (to which a tagalong inductor bias could be added) to the dimming detector and ripple control circuitry consisting of, in this particular example embodiment, op amps 152, 190, 202, and the associated components in FIG. 4 including other resistors, capacitors, diodes, etc. Resistors 146, 148 form a voltage divider that provides a reference voltage to op amp 152 which controls the gate of transistor 156 and provides ripple reduction by adjusting the drain voltage of 156 such that the load sees a primarily DC voltage with low ripple across the load. Resistor 162 is a sense resistor that provides feedback information to op amp 152 via RC network 160 and 154. Diodes 194, 164, 166, 170 and 222 provide level shifting and gating of the detect and control signals that are fed to optocoupler 220 which sends a control signal to the PWM controller 218 that, in this particular example embodiment controls the variable pulse generator 216 which, for this particular example embodiment is illustrated as operating at a frequency of 100 kHz. In general, the frequency is typically in the range of −20 kHz to over 100 kHz and higher. In some embodiments, optocoupler 220 is either optional or not used. In other embodiments of the present invention, the on-time, off-time, frequency/period, etc. are varied as opposed to the constant frequency, variable on-time example embodiment shown in FIG. 4. Op amp 202 along with resistors 196, 204 and 224 and capacitors 206 and 200 form the dimming detector which feeds a reference voltage that depends on the dimming conditions from, for example, a Triac, Triac-based, and other types of forward and reverse dimmers (if a dimmer is present) to the input of the voltage divider reference that feeds op amp 152. Op Amp 190 and resistors 184, 192, 180, 174, 176, 172 and 182 work in conjunction with the other two op amp circuits to provide information, via optocoupler 220 to control and set the variable pulse generator 216. Not shown are overvoltage, overtemperature, short circuit protection, etc. that may also feed into optocoupler 220 or by other means to the PWM controller 218 or by other methods to protect from shorts, open circuits, transients, over voltage, overtemperature, overpower, etc. Resistor 210 can be used to detect and limit the current through switching transistor 212 which is part of and provides current/power the buck circuit depicted in FIG. 4. Not shown are optional snubbers including in some embodiments lossless snubbers and clamps as well as other control and protection circuitry. Again, one or more tagalong inductors and associated bias and/or detect circuitry and functions may be included in embodiments of the present invention including those related to the example shown in FIG. 4. Again, although a buck converter was shown and discussed in FIG. 4, this should not be interpreted or construed in any way or form as limiting for the present invention as any known topology, architecture, implementation, circuitry, etc. including, but not limited to, buck, boost, boost-buck, buck-boost, Cuk, SEPIC, flyback, one or more stage, forward converter including single and double converters, current mode, current fed, voltage mode, voltage fed, half bridge converter, full bridge converter, push-pull, totem pole, etc. may be used with the present invention.

The current limiter can be controlled based on any desired signal representing a circuit condition, such as peak AC voltage. In the embodiment of FIG. 4, the current limiter may be controlled by, for example, the bias feedback from a tag-along inductor, which is tied to the current, so if the current increases, the bias voltage increases, providing current control.

A LED driver with a current limiter which generates a bias voltage using a tag-along inductor may be used in accordance with some embodiments of the invention. The LED driver powers and controls a load 150 such as one or more LED or OLED lights, from a power source such as a DC rail, which may be derived from an AC input using a rectifier. A transistor (i.e., 212 in FIG. 4) is controlled by a variable pulse generator 216 or other control circuit through, for example, a gate or base signal, blocking or allowing current to flow from the DC rail to a ground through the transistor. Again, in the example embodiment in FIG. 4, as current flows through the transistor 212, it also flows through a series inductor 130, storing energy in the inductor 130. When the transistor 212 is turned off by the variable pulse generator 216, the inductor 130 releases energy, which circulates through a diode 126 or other secondary path and through the load 150. One or more optional capacitors may be connected in parallel with the load as shown.

A bias power source, in which current flows from a tag-along inductor wound with the buck, boost-buck, boost, buck-boost, etc. inductor may be used with embodiments of the present invention.

The control circuit generates a feedback signal to set the pulse width from the variable pulse generator 216, setting the load current at the desired level. A capacitor may be used to average the voltage fluctuations for the feedback signal. The current limiting and ripple reduction LED driver may include one or more time constants in any suitable location throughout the driver or distributed in multiple locations, and may be embodied in any suitable manner, not to be limited to example RC time constants disclosed herein.

The current limiter and ripple reduction monitors the drain voltage, and adjusts the voltage of feedback signal to modify the pulse width from the variable pulse generator. The current limiter and ripple reducer thus protects the LED load from conditions that might otherwise damage them. In other embodiments, such an arrangement may be used to produce a constant current over an extended range of either AC or DC input voltages.

A tag-along inductor may be used in accordance with some embodiments of the present invention. Although a bipolar junction transistor is depicted in parts of the schematic, any appropriate device, switch, etc. can be used including MOSFETs, JFETs, other types of FETs, etc.

In some embodiments, the load current is kept constant at the operating voltage via the detection, feedback and control, thus providing constant current for small voltage fluctuations around the expected operating voltage.

The above embodiments illustrate example implementations and are not to be construed as limiting in any way or form.

The op-amp(s) of one or more of the embodiments of the present invention may comprise comparators, difference amplifiers, summing amplifiers, or any other suitable devices, components, sub-circuits, circuits, etc.

There can be a combination of op-amps and comparators. A current monitor (i.e., a sense resistor or winding which can also be used for other purposes including providing power to certain parts of the driver) can be used to limit the current and reduce the output ripple to the load, etc. The sense resistor can, for example, sense current or voltage or power either directly or indirectly. The present invention can be made to provide analog, digital, pulse width (PWM), duty cycle, etc. control of the output of the power supply.

In various embodiments, 0-10 dimming can be readily and easily implemented with the present invention by providing a 0 to 10 V dimming signal (or a scaled version—e.g., 0 to 3 V using a simple voltage divider) in place of or in conjunction with the phase processor signal that is applied to either or both the reference that sets the current (or voltage) level or the pulse width generator input. For example, this can be accomplished by providing a 0-10 V dimming signal to a phase processor for use in controlling the output of the phase processor or by providing the 0-10 V dimming signal to the reference current generator against which the load current measurement is compared or by providing the 0 to 10 V signal (or an appropriately scaled version) to the input of the PWM pulse width generator. Some embodiments may be dual or more than dual (i.e., multiple) dimming, supporting the use of a 0-10 V dimming signal (or other voltage ranges including, but not limited to, 0 to 1 V, 0 to 3 V, 1 to 8 V, etc.) in addition to a Triac-based or other phase-cut or phase angle dimmer. In addition, the resulting dimming, including current or voltage dimming, can be either PWM (digital) and/or analog dimming or both or selectable either manually, automatically, or by other methods and ways including software, remote control of any type including wired, wireless, powerline control (PLC), etc. using analog and/or digital interfaces including, but not limited to, SPI, I2C, RS232, RS485, DMX, DALI, ZigBee, WiFi, IEEE 802, ISM bands, Bluetooth, the use of analog to digital converters (ADC), digital to analog converters (DAC), etc. The present invention may be used with other forms of dimming as discussed herein. In addition, the other forms of dimming may use voice, voice commands, voice recognition, gesturing, light, motion, sonar, infrared detectors, visible light detection, etc.

The present invention may provide thermal control or other types of control to, for example, a dimming LED driver. For example, the circuits shown in the figures or variations thereof may also be adapted to provide overvoltage or overcurrent protection, short circuit protection for, for example, a dimming LED driver, or to override and cut the phase and power to the dimming LED driver(s) based on any arbitrary external signal(s) and/or stimulus. The present invention can also include circuit breakers including solid state circuit breakers and other devices, circuits, systems, etc. that limit or trip in the event of an overload condition/situation. The present invention can also include, for example, analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design etc., topology, implementation, etc.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, Ćuk, SEPIC, flyback, forward-converters, etc. For the respective configurations, examples of which are mentioned above, constant on time, constant off time, constant frequency/period, variable frequency, variable on time, variable off time, etc., as examples, can be used with the present invention. The present invention works with both isolated and non-isolated designs including, but not limited to, buck, boost-buck, buck-boost, boost, flyback and forward-converters. The present invention itself may also be non-isolated or isolated, for example using a tag-along inductor or transformer winding or other isolating techniques, including, but not limited to, transformers including signal, gate, isolation, etc. transformers, optoisolators, optocouplers, etc. An example of a tag-along inductor embodiment is disclosed in U.S. patent application Ser. No. 13/674,072, filed Nov. 11, 2012 for a “Dimmable LED Driver with Multiple Power Sources” which is incorporated herein by reference for all purposes.

The present invention includes other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

When the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention.

The transistors, switches and other devices, etc. may include any suitable type of transistor or other device, such as a bipolar transistor, including bipolar junction transistors (BJTs) and insulated gate bipolar transistors (IGBTs, or a field effect transistor (FET) including n and/or p channel FETs such as junction FETs (JFETs), metal oxide semiconductor FETs (MOSFETs), metal insulator FETs (MISFETs), metal emitter semiconductor FETs (MESFETs) of any type and material including but not limited to silicon, gallium arsenide, indium phosphide, gallium nitride, silicon carbide, silicon germanium, diamond, graphene, and other binary, ternary and higher order compounds of these and other materials. In addition, complementary metal oxide semiconductor n and p channel MOSFET (CMOS), heterojunction FET (HFET) and heterojunction bipolar transistors (HBT), bipolar and CMOS (BiCMOS), BCD, modulation doped FETs, (MODFETs), etc, and can be made of any suitable material including ones made of silicon, gallium arsenide, gallium nitride, silicon carbide, etc. which, for example, has a suitably high voltage rating. The variable pulse generator may use any suitable control scheme, such as duty cycle control, frequency control, pulse width control, pulse width modulation, etc. Any type of topology including, but not limited to, constant on time, constant off time, constant, frequency, variable frequency, variable duration, discontinuous, continuous, critical conduction modes of operation, CUK, SEPIC, boost-buck, buck-boost, buck, boost, etc. may be used with the present invention. The use of the term variable pulse generator is not intended to be limiting in any way or form but merely to attempt to describe part of the function performed by the present invention, namely to provide a signal that switches power (i.e., current and voltage) to a load such as the LED discussed in the present invention. The variable pulse generator can be made, designed, built, manufactured, implemented, etc. in various ways including those involving digital logic, digital, circuits, state machines, microelectronics, microcontrollers, microprocessors, digital signal processors, field programmable gate arrays (FPGAs), complex logic devices (CLDs), microcontrollers, microprocessors, analog circuits, discrete components, band gap generators, timer circuits and chips, ramp generators, half bridges, full bridges, level shifters, difference amplifiers, error amplifiers, logic circuits, comparators, operational amplifiers, flip-flops, counters, AND, NOR, NAND, OR, exclusive OR gates, etc. or various combinations of these and other types of circuits.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. The present invention can use constant on-time, constant off-time, constant period/frequency, variable period/frequency, etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) such as metal oxide semiconductor field effect transistors (MOSFETs) including either p-channel or n-channel MOSFETs, junction field effect transistors (JFETs), metal emitter semiconductor field effect transistors, etc. again, either p-channel or n-channel or both, bipolar junction transistors (BJTs), heterojunction bipolar transistors (HBTs), high electron mobility transistors (HEMTs), unijunction transistors, modulation doped field effect transistors (MODFETs), etc., again, in general, re-channel or p-channel or both, vacuum tubes including diodes, triodes, tetrodes, pentodes, etc. and any other type of switch, etc. The current limiter can used with LED drivers designed for continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A driver circuit comprising:
an AC input;
an electromagnetic interference filter connected to the AC input;
a rectifier connected to the electromagnetic interference filter;
a variable pulse generator connected to the rectifier;
an output driver connected to the variable pulse generator;
a control circuit connected to the variable pulse generator; and
a load output.
